(19) United States
(12) Patent Application Publication
(10) Pub. No.: US 2011/0018962 A1
(43) Pub. Date: Jan. 27, 2011

(54) Video Conferencing Signal Processing System

(76) Inventors: Shao-Chieh Lin, Hsichih (TW); Chien-Tang Tseng, Hsichih (TW); Chih-Jung Wei, Hsichih (TW); Chih-Hsiang Lin, Hsichih (TW); Chun-Hua Lee, Hsichih (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/761,458

(22) Filed: Apr. 16, 2010

(30) Foreign Application Priority Data
Jul. 21, 2009 (TW) 098124615

(51) Int. Cl. H04N 7/15

(52) U.S. Cl. 348/14.13; 348/E07.083

(57) ABSTRACT

A video conferencing signal processing system is disclosed. The video conferencing signal processing system comprises a receiver and a sender. An original video signal captured from the sender is capable of being processed into an encoded video conferencing signal by monitoring an output status of a video conferencing module of the receiver and processing the original video signal according to the output status of the receiver. The present invention reduces the consumption of system resources and the necessary transmitting bandwidth for video conferencing.

### BACKGROUND OF THE INVENTION

1. Field of the Invention

The present invention relates to a video conferencing signal processing system; more particularly, the present invention relates to a video conferencing signal processing system capable of reducing consumption of computer system resources and network transmission bandwidth used in video conferencing.

2. Description of the Related Art

With the development of image processing and network transmission techniques, it is common to hold a bi-directional conference or a multi-directional conference via a video conferencing mechanism. A video conference can be held any time and anywhere without being limited to a specific meeting time or location. Further, compared to a telephone connection, a video conferencing connection is more convenient because it is capable of providing real-time image information on the participating parties.

In the conventional video conferencing mechanism, most of the video conferencing signals are transmitted by means of computer to execute software with a related video conferencing function, wherein the video conferencing signals comprise both video signals and audio signals. However, such software consumes a large amount of computer system resources and occupies most of the network transmission bandwidth when transmitting the video conferencing signals via a network. When a network connection is not stable or the computer system resources are insufficient, the received video or audio signals may lag or be discontinuous. Therefore, it is necessary to develop a sophisticated video conferencing mechanism to reduce the consumption of system resources and network transmission bandwidth required by video conferencing software so as to improve data transmission efficiency as well as to reduce the impact on users.

### SUMMARY OF THE INVENTION

It is an object of the present invention to provide a video conferencing signal processing system capable of reducing consumption of computer system resources and network transmission bandwidth used in video conferencing.

To achieve the abovementioned object, the video conferencing signal processing system of the present invention comprises a receiver and a sender. The sender comprises an image capturing device and an encoding module. The image capturing device is used for capturing an original signal. The encoding module is used for encoding the original signal so as to generate a video conferencing signal. The receiver comprises a video conferencing module for receiving and outputting the video conferencing signal. The video conferencing module further comprises a status monitoring module for monitoring a signal output status of the video conferencing module, in order to generate output status information. The encoding module of the sender obtains the output status information before performing an encoding process in which the encoding module encodes the original signal according to the output status information. According to the abovementioned design, the video conferencing signal processing system of the present invention can perform a corresponding encoding process on the original signal based on different situations so as to optimize the encoding of the video conferencing signal.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a schematic drawing of a video conferencing signal processing system according to the present invention.

FIG. 2 illustrates a schematic drawing showing the process by which the video conferencing signal processing system determines whether the signal output status is a primary status or a secondary status according to the present invention.

FIG. 3 illustrates a schematic drawing showing an encoding adjustment to a partial region of the image of the video conferencing signal processing system according to the present invention.

### DETAILED DESCRIPTION OF THE PREFERRED EMBODIMENT

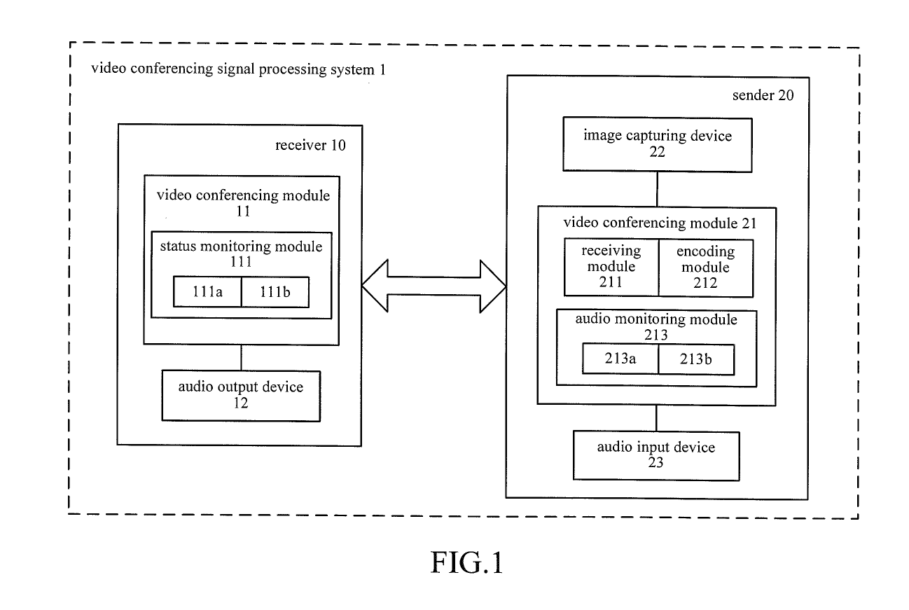

Please refer to FIG. 1, which illustrates a schematic drawing of a video conferencing signal processing system 1 according to the present invention. As shown in FIG. 1, the video conferencing signal processing system 1 of the present invention comprises a receiver 10 and a sender 20. A bi-directional video conferencing signal transmission function can be processed between the receiver 10 and the sender 20. In this embodiment, both the receiver 10 and the sender 20 are computer devices, but please note that the scope of the present invention is not limited to the above description.

The receiver 10 comprises a video conferencing module 11 and an audio output device 12. The video conferencing module 11 is used for receiving and outputting a video conferencing signal transmitted from the sender 20, wherein a video signal of the video conferencing signal is outputted via a window format interface, and au audio signal of the video conferencing signal is outputted via the audio output device 12. The audio output device 12 can be a speaker. The video conferencing module 11 further comprises a status monitoring module 111 for monitoring a signal output status of the video conferencing module 11, so as to generate output status information. The output status information includes information selected from one of the following: image output window status information of the video conferencing module 11, and audio output status information of the video conferencing module 11.

With regard to a video signal processing procedure, the video conferencing signal processing system 1 of the present invention performs a corresponding encoding process according to the image output window status information of the video conferencing module 11 of the receiver 10. Therefore, the status monitoring module 111 is used to monitor an image output window status of the video conferencing module 11, so as to further obtain the corresponding image output window status information. The image output window status information includes a window status parameter and a window coordinate parameter. For certain requests, a user of the receiver 10 may perform one of the following actions: temporarily scale up/down the image output window of the video conferencing module 11 on a desktop of an operating system, adjust the size of the image output window, or cover the image output window of the video conferencing module 11 with another software window. All of the above operations by the user will change the status of the image output window. The aforementioned window status parameter indicates the status of the image output window of the video conferencing module 11, wherein the status is selected from one of the following: a minimized window, a window scaling ratio, and a window covering status. The window coordinate parameter indicates a coordinate of the image output window of the video conferencing module 11.

With regard to an audio signal processing procedure, the video conferencing signal processing system 1 of the present invention performs a corresponding encoding process according to the audio output status information of the audio output device 12 of the receiver 10. Therefore, the status monitoring module 111 is also used to monitor an audio output status of the audio output device 12. The user of the receiver 10 may turn on/off the audio output device 12 or perform a volume output adjustment to the audio output device 12 based on different requirements. Therefore, the audio output status of the video conferencing signal outputted from the receiver 10 will be accordingly changed. All of the above operations will change the status of the audio output device 12.

The monitoring processes of obtaining corresponding window status parameters according to abovementioned output signal statuses will be described in detail hereinafter:

1. Minimized window: The video conferencing signal processing system 1 of the present invention utilizes the status monitoring module 111 to obtain a current window coordinate parameter of the image output window of the video conferencing module 11, so as to determining whether the image output window is at a minimized window status.

2. Window scaling ratio: The video conferencing signal processing system 1 of the present invention utilizes the status monitoring module 111 to obtain a current window coordinate parameter of the image output window of the video conferencing module 11, and to compare the current image output window with a predetermined image output window of the video conferencing module 11, so as to calculate and determine the scaling ratio of the image output window.

3. Window covering status: The video conferencing signal processing system 1 of the present invention utilizes the status monitoring module 111 to obtain a current coordinate of the image output window of the video conferencing module 11 and a current coordinate of at least one other window. Then the present invention determines whether the image output window is covered by the at least one other window according to their current coordinates, and also determines whether the image output window is partially or completely covered, so as to further obtain the window coordinate parameter. If the image output window is partially covered, the status monitoring module 111 can utilize the current coordinates to calculate a covered percentage of the image output window, so as to obtain the window coordinate parameter. In this embodiment, the window coordinate parameter indicates a coordinate where the image output window of the video conferencing module 11 is covered.

4. The status of the audio output device 12: The video conferencing signal processing system 1 of the present invention utilizes the status monitoring module 111 to monitor whether the audio output device 12 is turned on or whether its output volume is turned to zero. The status monitoring module 111 can also monitor an audio output quality of the audio output device 12. For example, the status monitoring module 111 can monitor whether the audio output device 12 is adjusted from multi-channel output to single-channel output.

The sender 20 comprises a video conferencing module 21 and an image capturing device 22. The image capturing device 22 is used for capturing an original signal from a current location of a user's sender 20. The video conferencing module 21 can be video conferencing software for transmitting the original signal to the receiver 10. The video conferencing module 21 comprises a receiving module 211 and an encoding module 212. The encoding module 212 is used for encoding the original signal to generate a video conferencing signal. The receiving module 211 is used for receiving the output status information transmitted from the receiver 10. Before performing an encoding process, the encoding module 212 obtains the output status information in advance, such that the encoding module 212 can encode the original signal according to the output status information, so as to generate the video conferencing signal. Then the video conferencing signal can be transmitted to the receiver 10 via the video conferencing module 21.

The video conferencing module 21 of the sender 20 further comprises an audio monitoring module 213. The audio monitoring module 213 is used for monitoring an input status of an audio input device 23 of the sender 20 to obtain input status information. The encoding module 212 can encode the original signal according to both the input status information and the abovementioned output status information. The audio input device 23 can be a microphone. The user of the sender 20 may turn on/off the audio input device 23 or perform a volume input adjustment to the audio input device 23 to change an inputted audio signal status. Then the audio monitoring module 213 can be utilized to monitor the status of the audio input device 23, such that the video conferencing signal processing system 1 of the present invention can perform a succeeding encoding process on audio data.

The status monitoring module 111 of the receiver 10 can be an application program interface (API) of an operating system, or a micro function circuit (MFC), such that the status monitoring module 111 can constantly or periodically detect the signal output status of the receiver 10. Please note that the status monitoring module 111 can be replaced by any other equivalent element without being limited to the above description. Similarly, the audio monitoring module 213 of the sender 20 can also adopt the same design, so as to constantly or periodically detect the input status of the audio input device 23 of the sender 20.

Both the signal output status monitored by the status monitoring module 111 of the receiver 10 and the input status of the audio input device 23 monitored by the audio monitoring module 213 of the sender 20 can be determined as either a primary status or a secondary status. The primary status indicates that an encoding quality of the original signal cannot be lowered. For example, the primary status can be selected from one of the following situations: the image output window of the video conferencing module 11 of the receiver 10 is recovered from a minimized status to a non-minimized status, the image output window is enlarged, the covered area of the image output window is reduced, the audio output device 12 is turned on (or its volume is turned from zero to non-zero), and the audio input device 23 is turned on (or its volume is turned from zero to non-zero). The secondary status indicates that the encoding quality of the original signal can be lowered. For example, the secondary status can be selected from one of the following situations: the image output window of the video conferencing module 11 of the receiver 10 is minimized, the image output window is reduced, the covered area of the image output window is increased, the audio output device 12 is turned off (or its volume is turned to zero), and the audio input device 23 is turned off (or its volume is turned to zero).

The status monitoring module 111 can comprise a primary status detection module 111a and a secondary status detection module 111b. The secondary status detection module 111b detects the signal output status based on a first period to determine whether the above secondary status is active, and to generate the output status information according to the detection result to notify the sender 20, thereby facilitating a succeeding encoding process. The primary status detection module 111a detects the signal output status real-time or based on a second period to determine whether the above primary status is active, and to immediately generate the output status information according to the detection result to notify the sender 20. The second period is shorter than the first period. Similarly, the audio monitoring module 213 of the sender 20 can adopt the same design, such that a primary status detection module 213a and a secondary status detection module 213b can real-time or periodically detect the input status of the audio input device 23 of the sender 20.

As the signal output status is monitored, the status monitoring module 111 can determine whether the current signal output status is the primary status or the secondary status according to the abovementioned definition. If the signal output status is detected as the primary status, the primary status will not be changed before the first period ends even if there is any new signal output status.

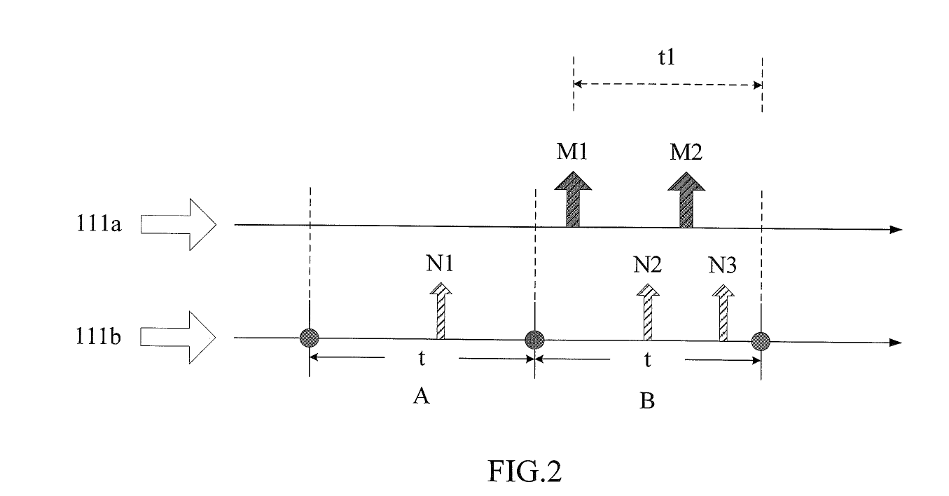

Please refer to FIG. 2, which illustrates a schematic drawing showing the process by which the video conferencing signal processing system 1 determines whether the signal output status is a primary status or a secondary status according to the present invention. For example, in a window minimization adjustment, as shown in FIG. 2, the secondary status detection module 111b periodically detects whether the image output window is minimized based on the first period t, and then records the output status information for transmission to the sender 20 after each period ends (shown as black points in FIG. 2); while the primary status detection module 111a real-time detects whether the image output window is recovered from a minimized status to a non-minimized status. During a time period A, the user minimizes the image output window (shown as an arrow N1 in FIG. 2); then the secondary status detection module 111b will detect the operation of N1 and determine the operation as a secondary status after the time period A ends. Therefore, this status will be recorded as the output status information for transmission to the sender 20 to perform a corresponding encoding process. During a time period B, the user recovers the image output window from the minimized status to the non-minimized status (shown as an arrow M1 in FIG. 2); then the primary status detection module 111a will immediately detect the primary status as the user performs this operation and accordingly record this status as the output status information for immediate transmission to the sender 20 to perform a corresponding encoding process. Between the operation of M1 and the end of the time period B (shown as a time period t1 in FIG. 2), whether the user minimizes the image output window (shown as an arrow N2 in FIG. 2) again, or repeatedly minimizes/recovers the image output window (shown as arrows N2, M2 and N3 in FIG. 2), neither the primary status detection module 111a nor the secondary status detection module 111b will record the newly detected signal output status as the output status information. The above design can prevent the sender 20 from performing too many corresponding encoding processes if the user repeatedly changes the signal output status within a short period of time. This is important because too many encoding processes performed within a short period of time may cause indistinct video or audio signals due to lack of processing time and resources for the video conferencing signal.

After receiving the output status information from the receiver 10, or further receiving the input status information, the sender 20 can perform a corresponding encoding process on the original signal based on different output status information (and input status information). After the encoding process, the original signal will be formed as the video conferencing signal accordingly. The encoding module 212 can respectively perform encoding processes on the video signal or the audio signal of the original signal. The encoding process of the encoding module 212 is a compression level adjustment of the original signal, wherein the compression level adjustment is selected from one of the following: a frame per second (FPS) adjustment, a resolution adjustment, and a partial image area encoding adjustment. Please note that the compression level adjustment can also include other encoding processes related to the original signal without being limited to the above description. Each of the compression level adjustments will be respectively described in detail hereinafter:

1. Frame per second (FPS) adjustment: If the image output window of the video conferencing module 11 of the receiver 10 is minimized or completely covered by another window, the video conferencing module 21 of the sender 20 can reduce the FPS of the original signal according to the corresponding output status information so as to reduce the number of signal data throughput to be processed by both the sender 20 and the receiver 10. Under the abovementioned situation, because the user cannot see the image output window, the user's visual effect will not be influenced by the reduction of the FPS of the original signal.

2. Resolution or image quality adjustment: If the image output window of the video conferencing module 11 is determined as being reduced to a certain level according to a window coordinate comparison result, the video conferencing module 21 of the sender 20 will lower a frame resolution or an image encoding quality according to the corresponding output status information so as to reduce the consumption of system resources. In this case, there is no significant difference between a high-quality encoded image (such as a VGA or HD image) and a low-quality encoded image (such as a QVGA image) because they are displayed on a relatively small image output window.

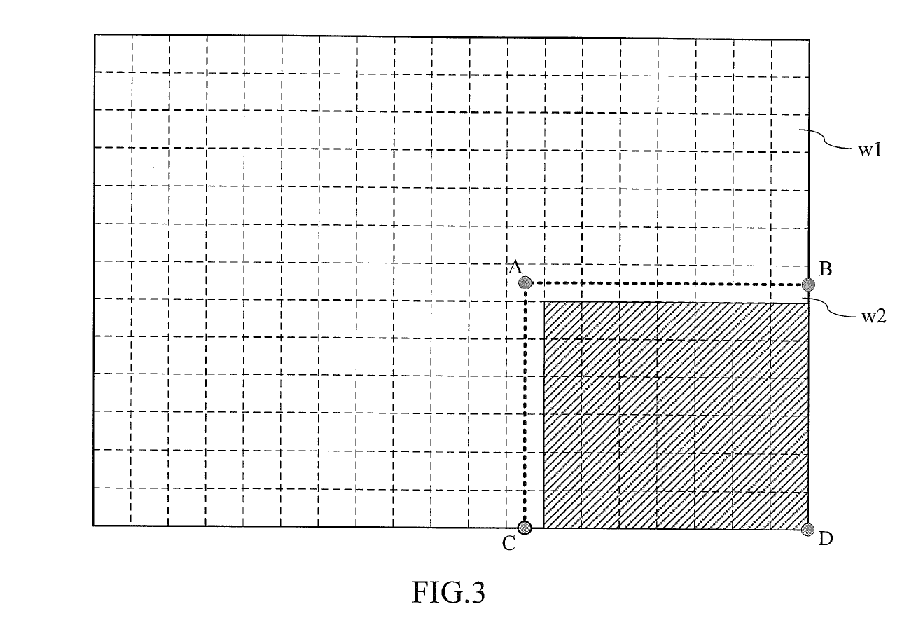

3. Partial image area encoding adjustment: Please refer to FIG. 3, which illustrates a schematic drawing showing an encoding adjustment to a partial region of the image of the video conferencing signal processing system 1 according to the present invention. As shown in FIG. 1 and FIG. 3, the image output window w1 of the video conferencing module 11 can be segmented into a plurality of identical blocks via the operation of the status monitoring module 111, each block with an assigned number. If the image output window w1 is partially covered by another window w2, coordinate values of four vertices A, B, C and D of an area where the window w2 substantially covers the image output window w1 can be obtained according to an already-obtained window coordinate. According to these four coordinate values, the size of the substantial covered area (shown as an area formed by bold dotted lines in the lower right corner in FIG. 3) of the image output window w1 can be calculated. Then a covered area will be obtained. The covered area is composed of a plurality of completely covered blocks within the substantial covered area (shown as a shaded area in FIG. 3). Locations of the plurality of completely covered blocks can be confirmed according to their assigned numbers. Therefore, after the above information has been transmitted to the sender 20, the encoding module 212 of the video conferencing module 21 can perform a specific encoding process on the covered area only, so as to partially reduce the encoding quality of the video data. In this embodiment, the image output window w1 is covered by only one window w2. However, if the image output window w1 is covered by multiple windows w2, the aforementioned partial image area encoding adjustment can also be applicable without being limited to the scope of this embodiment.

4. Audio encoding suspension or resumption: If the status monitoring module 111 determines that the audio output device 12 is turned off or its output volume is turned to zero, it implies that the receiver 10 cannot play the audio signal. Therefore, the video conferencing module 21 of the sender 20 will suspend an audio encoding process of the original signal according to the output status information, so as to reduce an unnecessary audio signal processing. Likewise, if the audio monitoring module 213 determines that the audio input device 23 is turned off or its input volume is turned to zero, it implies that the sender 20 does not input the audio signal. Therefore, the audio encoding process of the original signal would also be suspended.

On the other hand, if the status monitoring module 111 determines that the audio output device 12 is turned on or its volume is turned from zero to non-zero, it implies that the receiver 10 can play the audio signal. In this case, the video conferencing module 21 of the sender 20 will resume the audio encoding process of the original signal according to the output status information. Likewise, if the audio monitoring module 213 determines that the audio input device 23 is turned on or its input volume is turned from zero to non-zero, it implies that the sender 20 can play the audio signal. Therefore, the audio encoding process of the original signal would also be resumed.

5. Audio quality adjustment: If an audio output quality adopted by the audio output device 12 of the receiver 10 is lower than an audio input quality adopted by the audio input device 23 of the sender 20 (for example, the audio output device 12 is single-channel, while the audio input device 23 is multi-channel, such that the audio output device 12 does not support a high-quality audio output), the encoding module 212 of the video conferencing module 21 will reduce a compression encoding quality of the audio signal to reduce the bandwidth consumption and an unnecessary signal process.

Accordingly, the video conferencing signal processing system 1 of the present invention can perform a corresponding encoding process to the original signal according to different monitored video or audio signal statuses, so as to adjust an encoding quality of a formed video conferencing signal, thereby achieving an optimal encoding effect.

Furthermore, also as shown in FIG. 1, after the sender 20 performs the encoding process on the original signal to form the video conferencing signal, the video conferencing module 21 of the sender 20 will transmit the video conferencing signal to the receiver 10, such that the video conferencing module 11 of the receiver 10 can output the video conferencing signal. After the encoding process, the video and audio encoding quality of the video conferencing signal can be correspondingly adjusted according to the abovementioned output status information (and the input status information), so as to efficiently control its data transmission bandwidth and data processing throughput. The video conferencing module 11 of the receiver 10 can reduce unnecessary system resource waste when outputting the video conferencing signal. Therefore, if the receiver 10 is a laptop computer, its power consumption can be reduced to extend its usage time by means of applying the video conferencing signal processing system of the present invention. Also as shown in FIG. 3, with regard to the process to the area where the image output window w1 is partially covered by the window w2, the covered area for the encoding process is smaller than the substantial covered area of the image output window w1. When the video conferencing module 11 of the receiver 10 is outputting the video conferencing signal, no image inconsistency will occur in the superimposed edge (shown as line AB and line AC in FIG. 3) between the video conferencing signal of the image output window w1 and the other window w2, thereby providing a comfortable viewing effect for the user.

As compared to the prior art, which only performs a general encoding process on the original signal, the video conferencing signal generated after the encoding process of the video conferencing signal processing system 1 of the present invention can adjust the encoding quality of the video signal and the audio signal of the original signal according to either a primary status, in which the encoding quality of the original signal cannot be lowered, or a secondary status, in which the encoding quality of the original signal can be lowered. Therefore, it can reduce the data transmission throughput to reduce the data transmission bandwidth and the system resource consumption.

Accordingly, the video conferencing signal processing system 1 of the present invention can be applied in a general network video conversation or a video conference. Because both parties can be the sender and the receiver, each party can perform signal monitoring and related encoding processes on his/her counterpart at the same time, so as to reduce the consumption of system resources and bandwidth for both parties.

Although the present invention has been explained in relation to its preferred embodiments, it is to be understood that many other possible modifications and variations can be made without departing from the spirit and scope of the invention as hereinafter claimed.

What is claimed is:

1. A video conferencing signal processing system, comprising:
a sender, comprising:
an image capturing device for capturing an original signal; and
an encoding module for encoding the original signal so as to generate a video conferencing signal;
and
a receiver, comprising a video conferencing module for receiving and outputting the video conferencing signal, wherein the video conferencing module further comprises a status monitoring module for monitoring an output status of the video conferencing module, so as to generate output status information;
wherein the encoding module of the sender obtains the output status information before performing an encoding process, such that the encoding module encodes the original signal according to the output status information.

2. The video conferencing signal processing system as claimed in claim 1, wherein the output status information includes information selected from one of the following: image output window status information of the video conferencing module and audio output status information of the video conferencing module.

3. The video conferencing signal processing system as claimed in claim 2, wherein the image output window status information includes a window status parameter and a window coordinate parameter.

4. The video conferencing signal processing system as claimed in claim 3, wherein the window coordinate parameter indicates a coordinate of an image output window of the video conferencing module.

5. The video conferencing signal processing system as claimed in claim 3, wherein the window status parameter indicates a status of an image output window of the video conferencing module, wherein the status is selected from one of the following: a minimized window, a window scaling ratio, and a window covering status.

6. The video conferencing signal processing system as claimed in claim 5, wherein the window coordinate parameter indicates a coordinate where the image output window of the video conferencing module is covered.

7. The video conferencing signal processing system as claimed in claim 5, wherein the window scaling ratio is determined by means of utilizing the window coordinate parameter to compare a current image output window with a predetermined image output window.

8. The video conferencing signal processing system as claimed in claim 1, wherein the encoding process of the encoding module is a compression level adjustment of the original signal.

9. The video conferencing signal processing system as claimed in claim 8, wherein the compression level adjustment is selected from one of the following: a frame per second (FPS) adjustment, a resolution adjustment, and a partial image area encoding adjustment.

10. The video conferencing signal processing system as claimed in claim 9, wherein the partial image area encoding adjustment is used to reduce an encoding quality of at least one covered area of an image output window.

11. The video conferencing signal processing system as claimed in claim 1, wherein the sender further comprises an audio monitoring module for monitoring an input status of an audio input device, so as to obtain input status information.

12. The video conferencing signal processing system as claimed in claim 11, wherein the encoding module encodes the original signal according to both the output status information and the input status information.

13. The video conferencing signal processing system as claimed in claim 12, wherein when the audio input device is turned off or the volume of the audio input device is turned to zero, the encoding module encodes the original signal.

14. A video conferencing signal processing system, comprising:
a video conferencing module for transmitting a video conferencing signal to a remote device, wherein the video conferencing module comprises:
a remote status receiving module for receiving output status information from the remote device; and
an encoding module for encoding the video conferencing signal according to the output status information, wherein the encoded video conferencing signal has a comparably lower encoding quality.

15. The video conferencing signal processing system as claimed in claim 14, wherein the video conferencing signal comprises one of the following: a video signal and an audio signal.

16. A video conferencing signal processing system, comprising:
a video conferencing module for transmitting a video conferencing signal to a remote device, wherein the video conferencing module comprises:
a status monitoring module for monitoring a signal input status of the video conferencing module and a signal output status of the remote device; and
an encoding module for encoding the video conferencing signal according to either the signal input status or the signal output status, wherein the encoded video conferencing signal has a comparably lower encoding quality.

17. The video conferencing signal processing system as claimed in claim 16, wherein the video conferencing signal comprises one of the following: a video signal and an audio signal.
